(19) United States
(12) Patent Application Publication
(10) Pub. No.: US 2009/0084923 A1
(43) Pub. Date: Apr. 2, 2009

(54) Adjustable Multi-function Support Assembly

(76) Inventor: Chung-Yi LIN, Taichung County (TW)

Correspondence Address: Dr. BANGER SHIA, 102 Lindencrest Ct., Sugar Land, TX, 77479-5201, US

(21) Appl. No.: 11/866,397

(22) Filed: Oct. 2, 2007

(51) Int. Cl. F16M 11/06

(52) U.S. Cl. 248/407

(57) ABSTRACT

An adjustable multi-function support assembly comprises an extension mechanism, a first abutting mechanism and a second abutting mechanism. The extension mechanism includes a plurality of tubes that are axially pivotally coupled with each other. An assistant sleeve is disposed between tubes for assisting the extension of the respective tubes, so that the user can adjust the support assembly according to the requirements. The extension mechanism further utilizes the anti-slip block disposed on the first abutting mechanism and the anti-slip block disposed on the second abutting mechanism to increase the abutting friction.

### BACKGROUND OF THE INVENTION

1. Field of the Invention

The present invention relates to a support assembly, and more particularly to an adjustable multi-function support assembly which can be adjusted according to the required height.

2. Description of the Prior Art

As for the conventional common daily necessities, such as clothes rack, bookshelf, basketball backstop, clothes horse, horizontal bar, lamp support, flower shelf and so on, no matter how the structure is designed, each must have a support rod used to support a specific object. However, the support rods for various specific objects vary in structure design due to the limitation of the structures and the functions of the various specific objects, in other words, the function of the respective support rods is nearly the same, but the support rods are not interchangeable, and it is necessary to develop a support rod of different structure for every object. Thereby, developing various structures with almost the same functions increases the manufacturing cost, which is uneconomical and limited in practical use, and some of the manufactured support rods are quite difficult to operate or assemble, and some occupy much space after being assembled.

The present invention has arisen to mitigate and/or obviate the afore-described disadvantages.

### SUMMARY OF THE INVENTION

The primary objective of the present invention is to provide an adjustable multi-function support assembly which can be adjusted according to the required height and can save the storage space.

The second objective of the present invention is to provide an adjustable multi-function support assembly which can exert the advantage of occupying no space. Thereby, no matter how large the space is, the present invention is quite suitable for assembling with the objects at any place for use.

Hence, an adjustable multi-function support assembly in accordance with the present invention comprises an extension mechanism, at least one positioning device, a first abutting mechanism and a second abutting mechanism.

The extension mechanism includes a plurality of tubes that are axially pivotally coupled with each other, between tubes is disposed an assistant sleeve for assisting an axial extension of the respective tubes, and each end of the extension mechanism includes a connecting portion.

The positioning device is inserted into the first tube, the assistant sleeve and the second tube.

One end of the first abutting mechanism is assembled to the connecting portion of one end of the extension mechanism, and the other end of the abutting mechanism includes an anti-slip for abutting against a predetermined position.

One end of the second abutting mechanism is assembled to connecting portion of the other end of the extension mechanism, and the other end of the abutting mechanism includes an anti-slip block for abutting against a predetermined position.

### BRIEF DESCRIPTION OF THE DRAWINGS

FIG. 1 is an exploded view of an adjustable multi-function support assembly in accordance with the present invention;

FIG. 2 is a partially exploded view of the adjustable multi-function support assembly in accordance with the present invention;

FIG. 3 is a longitudinal cross sectional view showing how the first tube, the assistant sleeve and the second tube are assembled in accordance with the present invention;

FIG. 4 is a longitudinal cross sectional view showing how the first tube is assembled with the first abutting mechanism in accordance with the present invention;

FIG. 5 is a longitudinal cross sectional view showing how the second tube is assembled with the second abutting mechanism in accordance with the present invention;

FIG. 6 is a perspective view showing the adjustable multi-function support assembly in accordance with the present invention being assembled with a hanger;

FIG. 7 is a perspective view showing the adjustable multi-function support assembly in accordance with the present invention being assembled with a basketball backstop;

FIG. 8 is a perspective view showing the adjustable multi-function support assembly in accordance with the present invention being assembled with a hanger and a cylindrical sand-bag;

FIG. 9 is a perspective view showing the adjustable multi-function support assembly in accordance with the present invention being assembled with a hammock;

FIG. 10 is a perspective view showing the adjustable multi-function support assembly in accordance with the present invention being assembled with a spherical sand-bag;

FIG. 11 is a perspective view showing the adjustable multi-function support assembly in accordance with the present invention being assembled with a dartboard;

FIG. 12 is a partially exploded view showing another positioning device in accordance with the present invention; and

FIG. 13 is a partially cross sectional view showing another positioning device of FIG. 12 in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

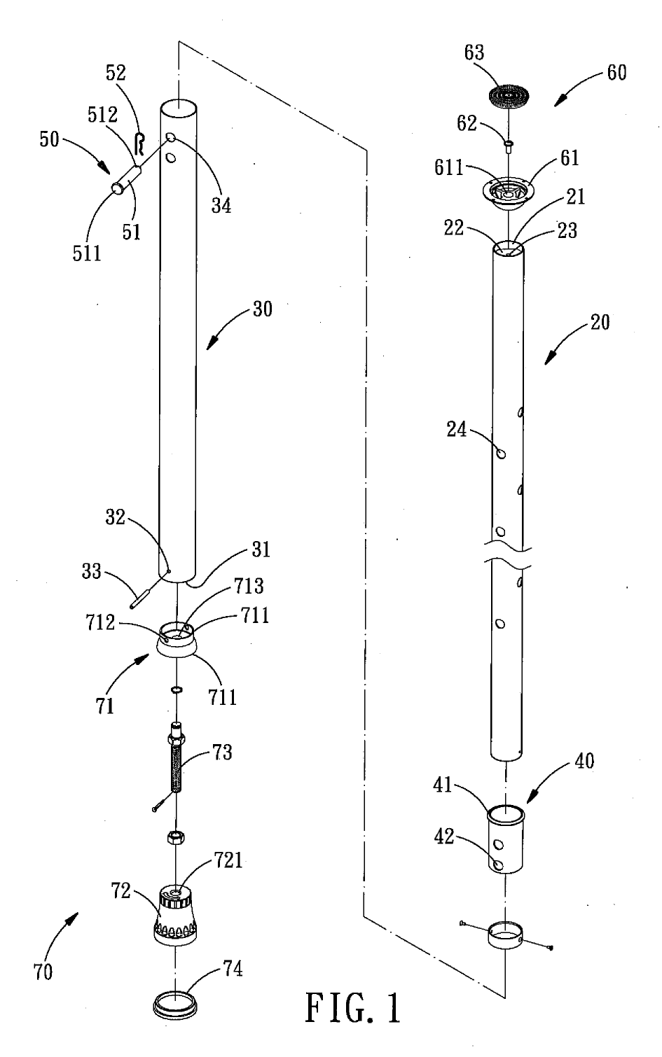

Referring to FIGS. 1-5, an adjustable multi-function support assembly in accordance with a preferred embodiment of the present invention comprises an extension mechanism 10 including a first tube 20, a second tube 30, an assistant sleeve 40 and a positioning device 50, a first abutting mechanism 60 and a second abutting mechanism 70.

The extension mechanism 10 is adjustable in length and abuts against the predetermined positions by both ends thereof. The extension mechanism 10 includes the first tube 20, the second tube 30, the assistant sleeve 40 and the positioning device 50. The first tube 20 is a hollow tube. One end of the first tube 20 is disposed with a connecting portion 21 which includes a positioning block 22. The positioning block 22 of the connecting portion 21 is formed on the inner wall of the first tube 20 and formed with a thread hole 23. The wall of the first tube 20 is formed with a plurality of positioning holes 24 that are alternately arranged or not alternately arranged. The respective positioning holes 24 are staggered with respect to each other.

The second tube 30 is a hollow tube. One end of the second tube 30 is disposed with a connecting portion 31 including two through holes 32. The two through holes 32 are aligned with each other for an insertion of a bolt 33. The other end of the second tube 30 is formed with two positioning holes 34 in the tube wall thereof.

The assistant sleeve 40 is a hollow structure. An inner diameter of the assistant sleeve 40 is bigger than an outer diameter of the first tube 20. An outer diameter of the assistant sleeve 40 is smaller than an inner diameter of the second tube 30. One end of the assistant sleeve 40 includes a flange 41 surrounding the outer wall thereof. The assistant sleeve 40 is formed with two positioning holes 42 in wall thereof. The assistant sleeve 40 is inserted into the second tube 30 first, and then the flange 41 of the assistant sleeve 40 abuts against the second tube 30 to prevent the assistant sleeve 40 from slipping into the second tube 30. The positioning holes 42 of the assistant sleeve 40 are aligned with the positioning holes 34 of the second tube 30.

The positioning device 50 includes a bolt 51 and a fastener 52. The outer diameter of the bolt 51 of the positioning device 50 is smaller than the inner diameter of the positioning hole 24 of the first tube 20. One end of the bolt 51 is radially disposed with a stopping flange 511 on the outer wall thereof, and the other end of the bolt 51 is radially formed with a through hole 512. The fastener 52 is U-shaped. The bolt 51 is correspondingly inserted into the positioning holes 24 of the first tube 20, the positioning holes 42 of the assistant sleeve 40 and the positioning holes 34 of the second tube 30, and the stopping flange 511 of the bolt 51 abuts against the outer wall of the second tube 30. The though hole 512 of the bolt 51 is exposed outside for an insertion of the fastener 52 to prevent the disengagement of the bolt 51 due to the outside-force, so that the positioning device 50 is substantially inserted into the positioning holes 24 of the first tube 20, the positioning holes 42 of the assistant sleeve 40 and the positioning holes 34 of the second tube 30.

The first abutting mechanism 60 includes a support block 61, a screw 62 and an anti-slip block 63. The support block 61 is a round bowl-shaped structure and formed with a thread hole 611 in the closed end thereof. The thread hole 611 of the support block 61 is aligned with the thread hole 23 of the connecting portion 21 of the first tube 20. The screw 62 is screwed into the thread hole 611 of the support block 61 of the first abutting mechanism 60 and the thread hole 23 of the connecting portion 21 of the first tube 20. The anti-slip block 63 is a round disc-shaped structure and engaged in the open end of support block 61.

The second abutting mechanism 70 includes a first support block 71, a second support block 72, a screw 73 and an anti-slip block 74. Both ends of the first support block 71 are axially formed with two flanges 711. The flange 711 of one end of the first support block 71 includes two through holes 712. The outer diameter of the flange 711 of this end is smaller than the inner diameter of the connecting portion 31 of the second tube 30. The two through holes 712 of the flange 711 of this end are aligned with the two though holes 32 of the connecting portion 31 of the second tube 30 for an insertion of the bolt 33. The first support block 71 is axially formed with a thread hole 713 at the center thereof.

The second support block 72 is a round basin-shaped structure and axially formed with a thread hole 721 in the closed end thereof. Both ends of the screw 73 are screwed into the thread hole 713 of the first support block 71 and the thread hole 721 of the second support block 72. The anti-slip block 74 is a round disk-shaped element to be engaged in the open end of the second support block 72.

The connecting portion 21 of the first tube 20 and the connecting portion 31 of the second tube 30 can substitute for each other, but the premise is that, the connecting portion 21 of the first tube 20 must be assembled to the first abutting mechanism 60, and the connecting portion 31 of the second tube 30 must be assembled to the second abutting mechanism 70.

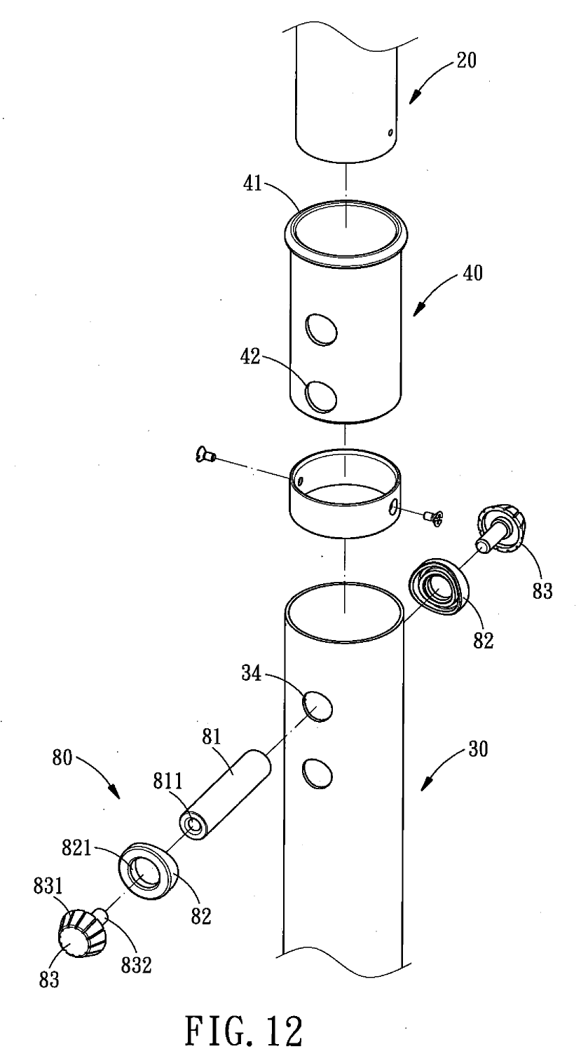

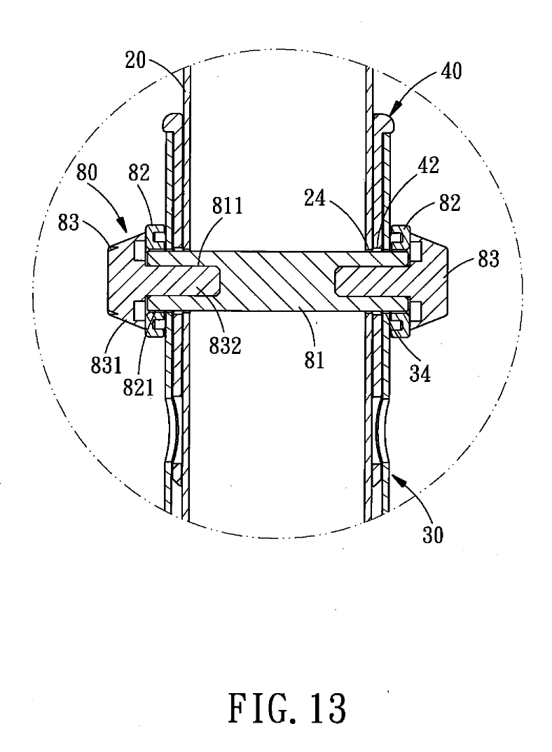

A positioning device 80 can be substituted for the above positioning device 50. The positioning device 80 (as shown in FIG. 12 and FIG. 13) includes a bolt 81, two assistant sleeve elements 82 and two engaging abutting elements 83. The outer diameter of the bolt 81 is smaller than the inner diameter of the positioning hole 24 of the first tube 20. The bolt 81 is longer than the diameter of the second tube 30, and each end of the bolt 81 is axially formed with a positioning concave 811. Each assistant sleeve element 82 is axially formed with a sleeve hole 821 at the center thereof. The inner diameter of the sleeve hole 821 of the assistant sleeve element 82 is greater than the outer diameter of the bolt 81. One end of each engaging abutting element 83 is formed with a stopping flange 831, and the other end is formed with a positioning protrusion 832 to be inserted into the positioning holes 24 of the first tube 20, the positioning holes 42 of the assistant sleeve 40 and the positioning holes 34 of the second tube 30. Both ends of the bolt 80 are exposed outside the second tube 30, so that the assistant sleeve elements 82 can be mounted on both ends of the bolt 81 by use of the sleeve holes 821 and abut against the outer wall of the second tube 30. Subsequently, the positioning protrusions 832 of the engaging abutting elements 83 are inserted into the positioning concaves 811 of the bolt 81 to let the stopping flanges 831 of the engaging abutting elements 83 abut against the assistant sleeve elements 82, so that the positioning device 80 is substantially inserted into the positioning holes 24 of the first tube 20, the positioning holes 42 of the assistant sleeve 40 and the positioning holes 34 of the second tube 30.

The aforementioned is the summary of the positional and structural relationship of the respective components of the preferred embodiment in accordance with the present invention.

For a better understanding of the present invention, its operation and function, reference should be made to FIGS. 1-11:

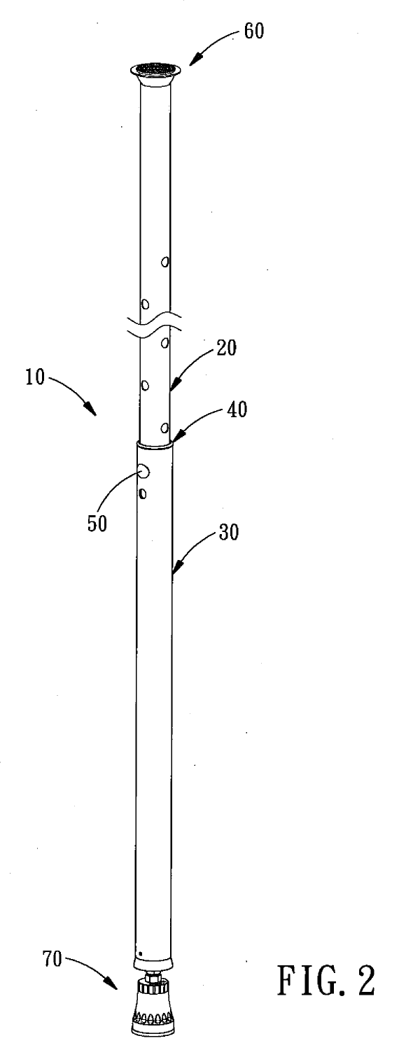

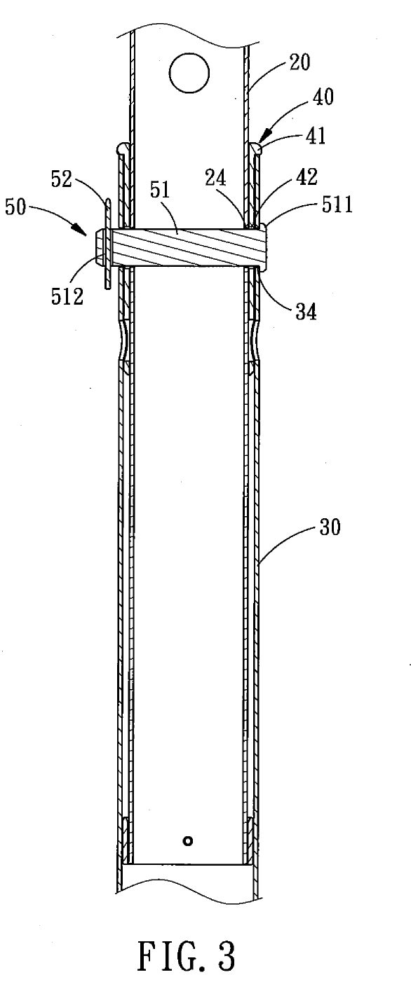

After the first tube 10, the second tube 30 and the assistant sleeve 40 of the extension mechanism 10 are assembled together, the positioning holes 24 of the first tube 20 can be moved in the second tube 30 by means of the assistant sleeve 40. After the total length of the first tube 20 and the second tube 30 is adjusted to a proper length, the positioning device 50 (please refer to FIGS. 2-3) is inserted into the positioning holes 24 of the first tube 20, the positioning holes 42 of the assistant sleeve 40 and the positioning holes 34 of the second tube 30, thus offering the function of easily adjusting the length of the extension mechanism 10 according to the requirements.

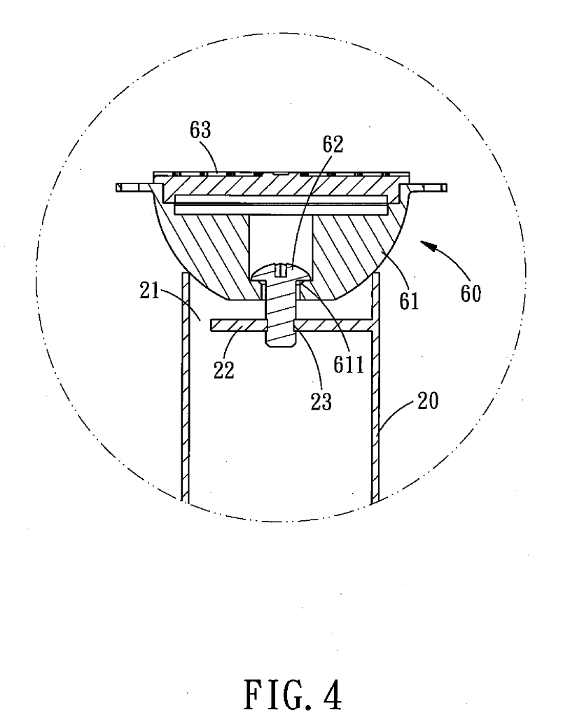

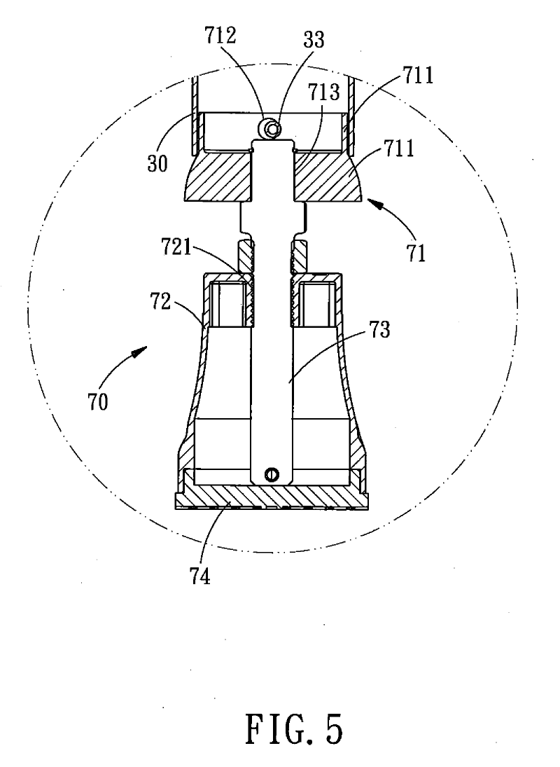

After that, the first abutting mechanism 60 and the second abutting mechanism 70 are assembled to the connecting portion 21 of the first tube 20 and the connecting portion 31 of the second tube 30 of the extension mechanism 10, respectively. The anti-slip block 63 of the first abutting mechanism 60 (as shown in FIG. 4) and the anti-slip block 74 of the second abutting mechanism 70 (as shown in FIG. 5) are used to enhance the required friction for abutting against the first tube 20 and the second tube 30 of the extension mechanism 10.

The present invention is called multi-functional support assembly, mainly because the support assembly of the present invention is suitable for many objects. There are several embodiments described as follows, such as hanger, basketball backstop, cylindrical sand bag, hammock, spherical sand bag and dartboard.

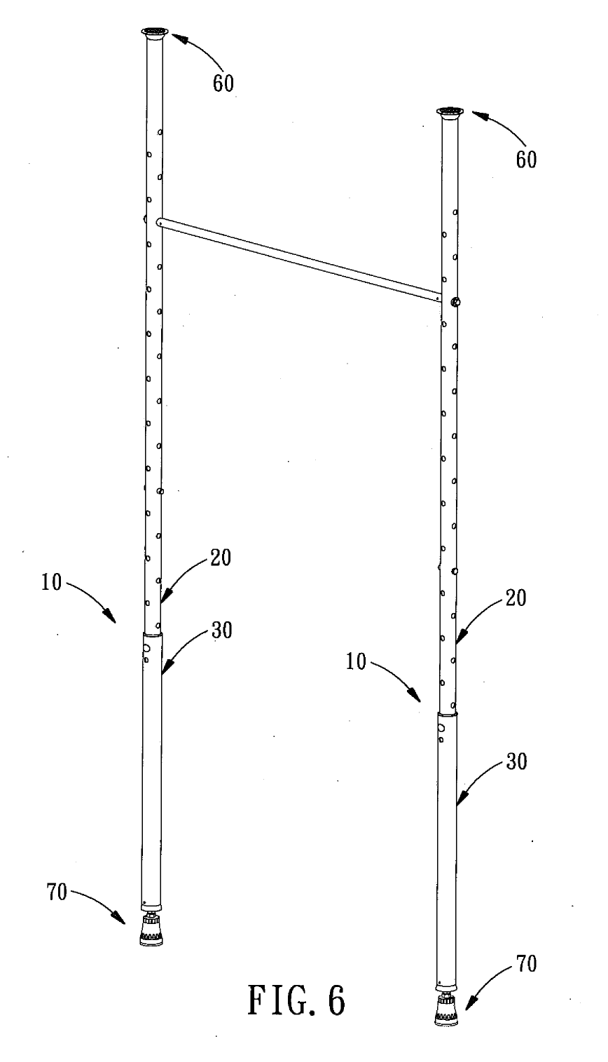

As shown in FIG. 6, two extension mechanisms 10 are used together with a hanger. Both ends of the hanger are assembled to the positioning holes 24 of the first tubes 20 of the two extension mechanisms 10 for hanging clothes.

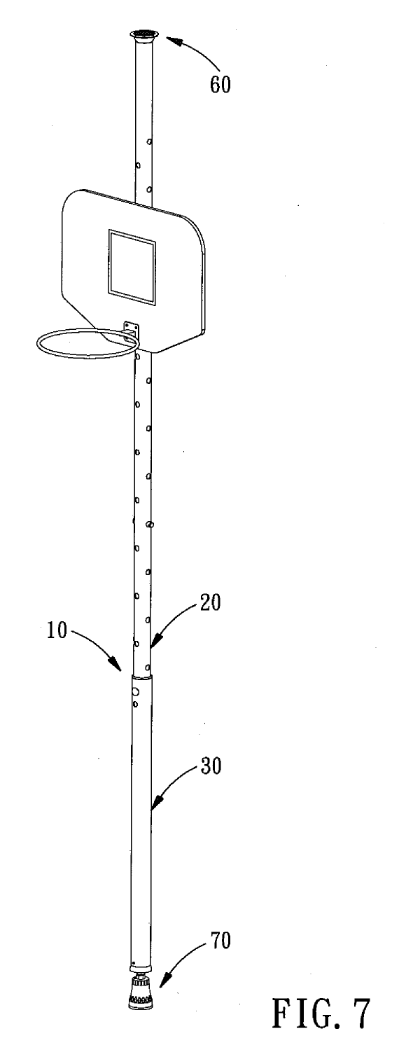

As shown in FIG. 7, the extension mechanism 10 is used together with a basketball backstop. The rear side of the basketball backstop is assembled to the positioning holes 24 of the first tube 20 of the extension mechanism 10 for playing basketball.

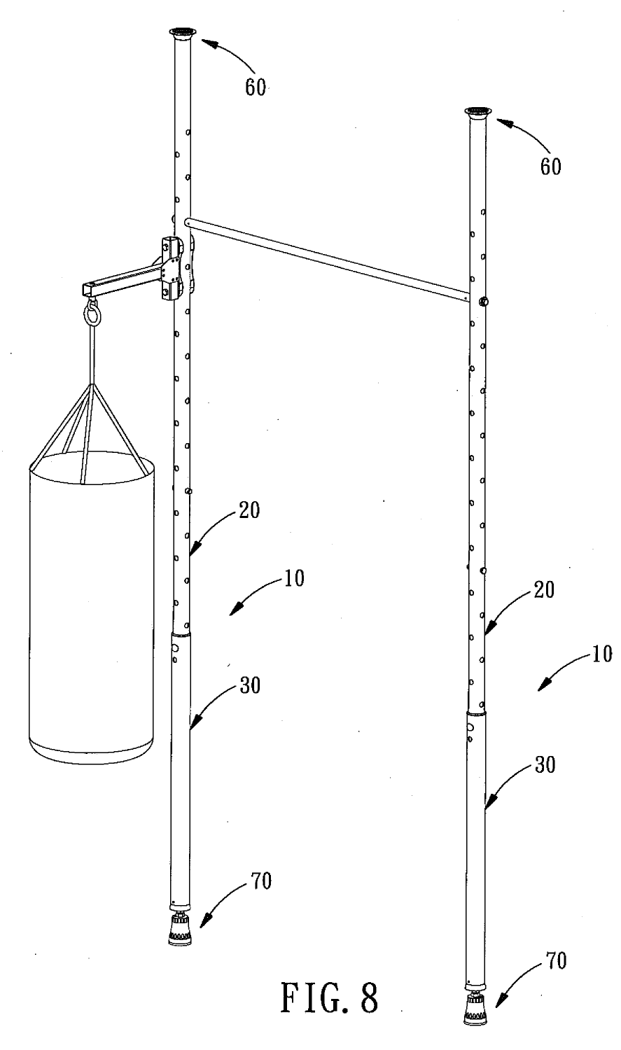

As shown in FIG. 8, two extension mechanisms 10 are used together with a hanger and a cylindrical sand-bag. Both ends of the hanger are assembled to the positioning holes 24 of the first tubes 20 of the two extension mechanisms 10 for hanging clothes. The cylindrical sand-bag is positioned to the positioning holes 24 of the first tube 20 of one of the extension mechanisms 10 by means of two clamping elements and a support element for playing boxing.

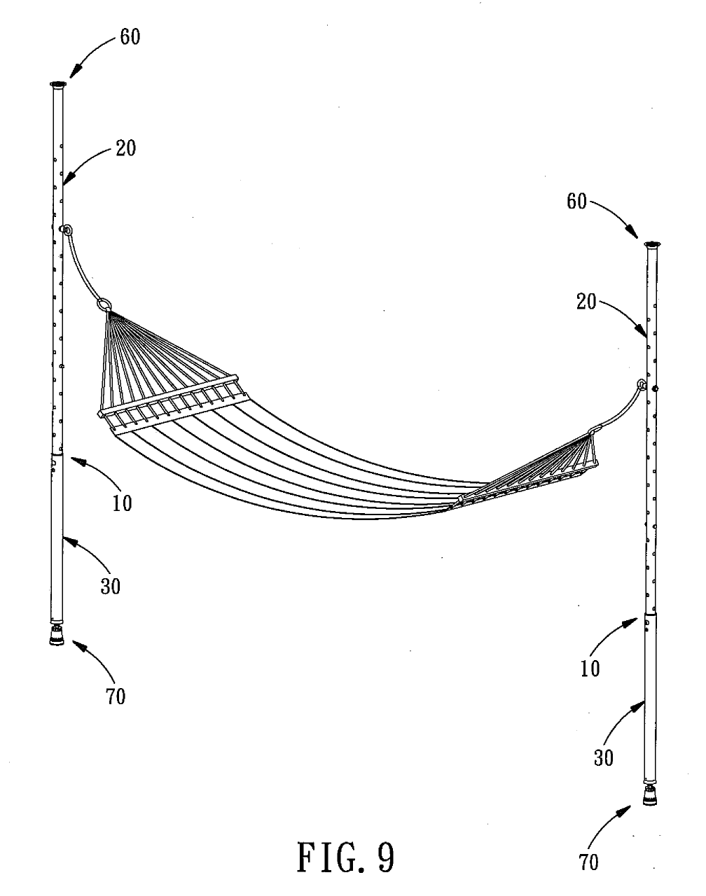

As shown in FIG. 9, two extension mechanisms 10 are used together with a hammock. Both ends of the hammock are assembled to the positioning holes 24 of the first tubes 20 of the two extension mechanisms 10 for supporting a human body.

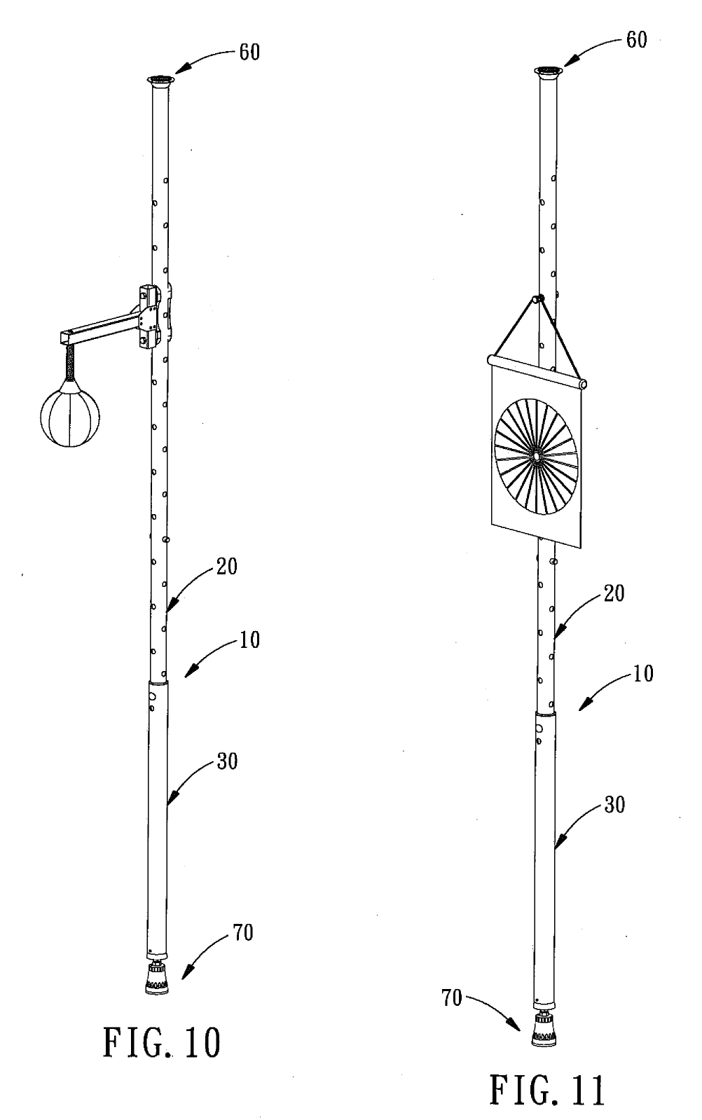

As shown in FIG. 10, an extension mechanism 10 is used together with a spherical sand bag. The spherical sand bag is positioned to the positioning holes 24 of the first tube 20 of the extension mechanism 10 by means of two clamping elements and a support element for playing boxing.

As shown in FIG. 11, an extension mechanism 10 is used together with a dartboard. One side of the dartboard is assembled to the positioning holes 24 of the first tube 20 of the extension mechanism 10 for darting.

The above hanger, basketball backstop, cylindrical sand bag, hammock, spherical sand bag and dartboard can be used together with at least one extension mechanism 10.

To summarize, the structure disclosed by the present invention can quickly offer a multi-function object for use by assembling the most simplified structures, substantially having the advantage of wide application range.

While we have shown and described various embodiments in accordance with the present invention, it is clear to those skilled in the art that further embodiments may be made without departing from the scope of the present invention.

What is claimed is:

1. An adjustable multi-function support assembly comprising: an extension mechanism, a first abutting mechanism and a second abutting mechanism; wherein
the extension mechanism includes a plurality of tubes that are pivotally coupled with each other, between tubes are disposed assistant sleeves for assisting an axial extension of each tube, each end of the extension mechanism includes a connecting portion;
one end of the first abutting mechanism is assembled to the connecting portion of one end of the extension mechanism, and the other end of the first abutting mechanism includes an anti-slip block for abutting against a predetermined position; and
one end of the second abutting mechanism is assembled to the connecting portion of the other end of the extension mechanism, and the other end of the second abutting mechanism includes an anti-slip block for abutting against a predetermined position.

2. The adjustable multi-function support assembly as claimed in claim 1, wherein
the extension mechanism further includes a first tube, a second tube and a positioning device, one end of the first tube includes a connecting portion for assembling with the first abutting mechanism, the connecting portion of the first tube includes a positioning block formed on an inner wall of the first tube, the positioning block of the connecting portion of the first tube is formed with a thread hole, the first tube is formed with a plurality of positioning holes that are alternately arranged or not alternately arranged, the respective positioning holes are staggered with respect to each other, one end of the second tube includes a connecting portion for assembling with the second abutting mechanism, the connecting portion of the second tube includes at least one through hole aligned with each other for an insertion of a bolt, the other end of the second tube includes at least one positioning hole in a tube wall thereof, the positioning device includes a bolt and a fastener, an outer diameter of the bolt of the positioning device is smaller than an inner diameter of the positioning hole of the first tube, one end of the bolt is radially disposed with a stopping flange surrounding an outer wall thereof, and the other end of the bolt is axially formed with a through hole, the bolt is inserted into the positioning holes of the first tube, the positioning holes of the assistant sleeve and the positioning holes of the second tube, the stopping flange of the bolt abuts against an outer wall of the second tube, and the through hole of the bolt is exposed outside for an insertion of the fastener; and
an inner diameter of the assistant sleeve is bigger than an outer diameter of the first tube, an outer diameter of the assistant sleeve is smaller than an inner diameter of the second tube, one end of the assistant sleeve is disposed with a flange surrounding an outer diameter thereof, the assistant sleeve is formed with at least one positioning hole in a wall thereof, the assistant sleeve is inserted into the second tube, and the flange of the assistant sleeve abuts against the second tube, the positioning holes of the assistant sleeve are aligned with the positioning holes of the second tube.

3. The adjustable multi-function support assembly as claimed in claim 2, wherein the first abutting mechanism includes a support block, a screw and an anti-slip block, the support block is formed with a thread hole in a closed end thereof to be aligned with the thread hole of the connecting portion of the first tube, the screw is screwed into the thread hole of the support block of the first abutting mechanism and the thread hole of the connecting portion of the first tube, the anti-slip block is engaged in an open end of the support block.

4. The adjustable multi-function support assembly as claimed in claim 2, wherein the second abutting mechanism includes a first support block, a second support block, a screw and an anti-slip block, both ends of the first support block are axially formed with two flanges, the flange of one end of the first support block includes two through holes, an outer diameter of the flange of this end is smaller than an inner diameter of the connecting portion of the second tube, the two through holes of the flange of this end are aligned with the two though holes of the connecting portion of the second tube for an insertion of the bolt, the first support block is axially formed with a thread hole, the second support block is formed with a thread hole in a closed end thereof, both ends of the screw are screwed into the thread hole of the first support block and the thread hole of the second support block, the anti-slip block is engaged into an open end of the second support block.

5. The adjustable multi-function support assembly as claimed in claim 1, wherein:
the extension mechanism includes a first tube, a second tube and a positioning device, one end of the first tube includes a connecting portion for assembling with the first abutting mechanism, the connecting portion of the first tube includes a positioning block formed on an inner wall of the first tube, the positioning block of the connecting portion of the first tube is formed with a thread hole, the first tube is formed with a plurality of positioning holes that are alternately arranged or not alternately arranged in a wall thereof, the respective positioning holes are staggered with respect to each other, one end of the second tube includes a connecting portion for assembling with the second abutting mechanism, the connecting portion of the second tube includes at least one through hole aligned with each other for an insertion of a bolt, the other end of the second tube includes at least one positioning hole in a tube wall thereof, the positioning device includes a bolt and at least one assistant sleeve element and at least one engaging abutting element, an outer diameter of the bolt of the positioning device is smaller than an inner diameter of the positioning hole of the first tube, the bolt is longer than an diameter of the second tube, each end of the bolt is axially formed with a positioning concave, each assistant sleeve element is axially formed with a sleeve hole, an inner diameter of the sleeve hole of each assistant sleeve element is bigger than an outer diameter of the bolt, one end of each engaging abutting element is formed with a stopping flange, and the other end of each engaging abutting element is formed with a positioning protrusion to be inserted in the positioning concave of the bolt, the bolt is to be inserted into the positioning holes of the first tube, the positioning holes of the assistant sleeve and the positioning holes of the second tube, the assistant sleeve elements of the positioning device are mounted on the bolt and abut against an outer wall of the second tube, the positioning protrusion of the engaging abutting element is inserted into the positioning concave of the bolt to make the stopping flange of the engaging abutting element abut against the assistant sleeve element of the positioning device.
an inner diameter of the assistant sleeve is bigger than an outer diameter of the first tube, an outer diameter of the assistant sleeve is smaller than an inner diameter of the second tube, one end of the assistant sleeve is disposed with a flange surrounding an outer diameter thereof, the assistant sleeve is formed with at least one positioning hole in a wall thereof, the assistant sleeve is inserted into the second tube, and the flange of the assistant sleeve abuts against the second tube, the positioning holes of the assistant sleeve are aligned with the positioning holes of the second tube.

6. The adjustable multi-function support assembly as claimed in claim 5, wherein the first abutting mechanism includes a support block, a screw and an anti-slip block, the support block is formed with a thread hole in a closed end thereof to be aligned with the thread hole of the connecting portion of the first tube, the screw is screwed into the thread hole of the support block of the first abutting mechanism and the thread hole of the connecting portion of the first tube, the anti-slip block is engaged in an open end of the support block of the first abutting mechanism.

7. The adjustable multi-function support assembly as claimed in claim 5, wherein the second abutting mechanism includes a first support block, a second support block, a screw and an anti-slip block, both ends of the first support block are axially formed with two flanges, the flange of one end of the first support block includes two through holes, an outer diameter of the flange of this end is smaller than an inner diameter of the connecting portion of the second tube, the two through holes of the flange of this end are aligned with the two though holes of the connecting portion of the second tube for an insertion of the bolt, the first support block is axially formed with a thread hole at a center thereof, the second support block is formed with a thread hole in a closed end thereof, both ends of the screw are screwed into the thread hole of the first support block and the thread hole of the second support block, the anti-slip block is engaged in an open end of the second support block.
